(19) United States
(12) Patent Application Publication
(10) Pub. No.: US 2023/0124078 A1
(43) Pub. Date: Apr. 20, 2023

(54) Cultivation Tray

(71) Applicant: GEGE Machinebouw B.V., Uden (NL)

(72) Inventor: Gijsbertus Hendrikus Ambrosius van Schaijk, Uden (NL)

(21) Appl. No.: 17/906,200

(22) PCT Filed: Mar. 15, 2021
(86) PCT No.: PCT/NL2021/050175

§ 371 Date: Sep. 13, 2022

(30) Foreign Application Priority Data
Mar. 13, 2020 (NL) 2025121

(51) Int. Cl. A01G 9/029; A01G 22/05; A01G 9/02

(52) U.S. Cl. CPC A01G 9/0295; A01G 22/05; A01G 9/0297; A01G 9/021

(57) ABSTRACT

The invention concerns a tray (20) for cultivating a crop or a precursor thereof, particularly a strawberry plant cultivation tray, wherein the tray (20) comprises an upper wall (32) with a number of holders (42) for holding therein the crop or precursor thereof, wherein the holders (42) are formed by a number of longitudinally extending rows of cup-shaped recesses in the upper wall (32), herein the upper wall (32) also comprises a groove-like recess (33) arranged between adjacent rows of cup-shaped recesses (40) and extending in longitudinal direction (PI).

The invention relates to a tray for cultivating plants or precursors thereof, particularly a strawberry plant cultivation tray. The invention also relates to a greenhouse system for cultivating a crop or a precursor thereof, provided with a number of such trays.

Strawberry plants are generally cultivated on a so-called tray field. A tray field is a field on which trays are placed in which the crop or the precursor thereof is arranged (this including plants, flowers, trees, bushes and the like). More particularly, each tray comprises a number of rows of cup-shaped holders, in each of which a crop or precursor thereof for cultivating can be placed. The ground surface of the field is covered with a watertight groundsheet so as to not allow passage of water and to protect the crop from weeds. Arranged on the ground surface are parallel concrete pathways along which equipment can be moved with which the crop can be treated, such as spraying equipment and equipment for placing and collecting the trays.

The trays on a first type of tray field lie disposed in rows on the groundsheet, wherein a small mutual distance is left clear between the rows of trays (typically between 15 cm and 20 cm), this mutual distance being kept clear so as to have space to walk along and process the crop. This has the result that relatively few plants can be cultivated per given surface area of the tray field. The intermediate distances have the further result that when the field is sprayed, a part of the spray falls in the space between the trays and is therefore lost. A relatively large amount of spray, and thereby a relatively larger quantity of crop protection products and/or fertilizers, are therefore necessary. This is costly and bad for the environment.

Patent document EP 3 167 705 A1 also describes a second type of tray field. The description of this type of tray field in said patent document is deemed included here. In this type of tray field use is made of a greenhouse system comprising a number of elongate tracks for supporting a number of parallel rows of trays. Each track can here comprise a number of elongate profiles. The profiles are supported at some height relative to the ground in order to reduce the effect of moisture and dirt splashing up. The trays are disposed on the profiles, this such that they are displaceable over the profiles in longitudinal direction. In determined embodiments of this greenhouse system the trays are supported in the centre by a single profile, and the two longitudinal edges of the tray remain clear. An advantage hereof is that the greenhouse system makes it possible to place more plants per unit of area since the intermediate distance between the rows of trays in the greenhouse system can be minimal, typically 5 cm or less, since no space need be left clear for a person to be able to walk along the trays. This intermediate space is important for providing the option of displacing crop treatment units, such as crop cutting units or crop trimming units, along the rows of cup-shaped holders so that the crop can be treated, for instance cut or trimmed, in simple manner at set times.

A drawback of this greenhouse system and the associated trays can be that the cultivation capacity per tray is fairly limited. Because each tray is supported only in the centre, and because a filled tray must be prevented from sagging too much under the weight of the crop, the number of rows of cup-shaped holders must be limited. In practice such a tray therefore usually comprises only two rows of cup-shaped holders. A maximum of two rows of cup-shaped holders is also necessary in order to always have an intermediate space alongside adjacent rows for the purpose of guiding the crop treatment units therealong.

There is therefore a need for a tray with a greater capacity. The problem however occurs here that a larger tray requires more support in order to prevent an excessive degree of sagging and/or in order to realize a sufficient degree of slidability along the profiles, but if the tray is supported at multiple positions, for instance at the longitudinal edges of the tray, the greenhouse system becomes much more extensive because more profiles are required. It is further important to preserve the above stated advantage of the second type of tray field, i.e. to provide the option for crop treatment units to be displaced along each row of cup-shaped holders. Finally, there is of course also a need to increase the potential capacity of a tray field still further.

According to a first aspect of the invention, a tray is provided for cultivating a crop or a precursor thereof, particularly a strawberry plant cultivation tray, wherein the tray comprises an upper wall with a number of holders for holding therein the crop or precursor thereof, wherein the holders are formed by a number of longitudinally extending rows of cup-shaped recesses in the upper wall, wherein the upper wall also comprises a groove-like recess arranged between adjacent rows of cup-shaped recesses and extending in longitudinal direction. The groove-like recess in longitudinal direction of the tray provides the option of arranging therein a crop treatment unit, such as a crop trimming unit or a crop cutting unit, so that the crop present in the adjacent row(s) of holders can be treated in simple manner and/or in only one process run (meaning that the treatment can be performed in one step for all the crops). The specific construction of the tray further provides the option of placing trays in mutually adjacent tracks tightly against each other. It is hereby possible to provide more trays and more holders per unit of area, which produces a cost saving, while the absence of intermediate space (gap) between adjacent rows or tracks of trays is accommodated by the presence of the one or more groove-like recesses. It is otherwise not essential to place the trays in mutually adjacent tracks tightly against each other. In determined embodiments the girder profiles on which the longitudinal edges of the trays rest can be embodied with a width such that some intermediate space (for instance about 2 cm) still remains between the trays at the position of the girder profiles. Plants can then also be treated, for instance trimmed, in this intermediate space.

In determined embodiments of the invention a tray comprises at least three rows of cup-shaped recesses, wherein at least one groove-like recess is arranged between adjacent rows of cup-shaped recesses. In a further preferred embodiment the tray comprises four rows of cup-shaped recesses and three groove-like recesses arranged between adjacent rows of cup-shaped recesses. It can be more efficient for a tray to have more than two rows, as was the case in the embodiment according to EP 3 167 705 A1.

In determined embodiments of the invention a tray comprises a number of sliding surfaces formed on the undersides of the two lateral side edges of the tray for the purpose of supporting the tray for sliding on top of girder profiles of a greenhouse system. The tray is thus supported at (at least) two positions lying relatively far apart.

In determined embodiments of the invention the tray comprises a number of guides formed on the lateral side edges of the tray for the purpose of guiding the tray between the side surfaces of adjacent girder profiles of a greenhouse system. In this way the trays can be shifted along the girder profiles in reliable manner.

In determined embodiments of the invention the tray is provided at the two longitudinal outer ends with one or more aligning elements for mutually aligning the trays. When the trays lie against each other on two shared girder profiles of the greenhouse system, the aligning elements ensure that these trays are aligned and remain aligned relative to each other, at least in transverse direction. This enhances the trimming/cutting.

In determined embodiments of the invention said aligning elements comprise recesses and corresponding protrusions. The recesses and protrusions are preferably provided at corresponding positions so that they can engage in each other during use.

In determined embodiments of the invention the groove-like recess extends over substantially the whole length of the tray. Alternatively or additionally, the groove-like recesses are embodied to form a substantially uninterrupted passage when a number of trays are placed one behind the other. This ensures that a crop treatment unit is able to pass along all trays of a track and can treat the crop arranged therein, without the trays having to be removed from the greenhouse system for this purpose. The displaceability of the crop treatment unit through the passage formed by groove-like recesses, placed one behind the other, of the upper walls of the respective trays is also enhanced if the width of the groove-like recess is constant over substantially the whole length of the tray.

In determined embodiments of the invention the tray comprises a number of depending strengthening walls extending in transverse direction and formed on the underside of the upper wall and on the underside of the groove-like recesses. These strengthening walls have the result, among others, that the tray is also sufficiently strengthened in transverse direction (transversely of the longitudinal or length direction), so that the chance of excessive sagging of the tray when it is placed on the greenhouse system is relatively small.

In determined embodiments of the invention the part of the upper wall between a row of cup-shaped recesses and a groove-like recess has a support surface for supporting a crop or precursor thereof arranged in the cup-shaped recesses. This support surface preferably has a width of at least 1 cm, still more preferably at least 2 cm.

In determined embodiments of the invention the upper wall has a non-recessed part, and this non-recessed part takes a substantially flat form. In other words, the whole upper side of the tray can take a flat form in this embodiment.

In determined embodiments of the invention the upper wall comprises one or more recesses which define engaging surfaces whereby the tray can be engaged and moved, for instance by movable pins whereby the tray can be displaced over the girder profiles.

In determined embodiments of the invention said recesses are arranged in the upper, non-recessed flat part of the upper wall, in other embodiments they are arranged in the groove-like recess(es), while in still other embodiments said recesses are arranged in both the upper, non-recessed flat part of the upper wall and in the groove-like recess(es). In further embodiments said recesses are provided at the longitudinal outer ends of the groove-like recesses.

In determined embodiments of the invention the groove-like recesses comprise a bottom, wherein one or more openings can be arranged in the bottom. These openings are configured to discharge water and/or to supply or discharge ventilation air with which the space under the trays can be ventilated.

In determined embodiments of the invention said bottom of the groove-like recess takes a wholly or partially rounded form. This reduces the risk of accumulation of dirt in the groove-like recess.

In determined embodiments of the invention the tray is manufactured from plastic.

According to another aspect of the invention, a greenhouse system for cultivating a crop or precursor thereof, provided with a number of the trays described herein, is provided.

In determined embodiments of the invention the greenhouse system comprises at least two elongate tracks for supporting at least a first and a second row of trays, wherein the tracks comprise at least three parallel girder profiles and a number of support parts for supporting the girder profiles at a substantially constant distance relative to the ground, and wherein at least one girder profile is embodied for supporting both the first row of trays and the second row of trays simultaneously.

In determined embodiments of the invention each girder profile is embodied to support the tray over the whole length thereof and/or wherein the girder profiles are manufactured from rolled profile material, in particular from rolled strip steel and/or the profiles take a smooth form at the upper outer end in order to enable displacement of the tray in longitudinal direction.

In determined embodiments of the invention the greenhouse system is configured to support the trays clear of the ground surface, preferably at a constant height, still more preferably at a constant height in the range of 0.2 to 0.6 m. In embodiments of the invention the girder profiles can be supported to the ground surface in different ways.

The invention also relates to the combination of the greenhouse system defined herein and at least a crop treatment unit for treating the crop in the crop holders of the trays placed in a track, wherein the crop treatment unit is configured to extend wholly or partially inside the groove-like recess.

Further advantages, features and details of the invention will be elucidated with reference to the following description of some embodiments thereof. Reference is made to the accompanying figures, in which the same elements are designated with the same reference numerals. The terms “under/above” and “upper/lower” and the like used herein further relate only to the orientation of the tray shown in the figures. In the figures:

FIG. 1 shows a front view or section over one track with a rail profile on either side. The right-hand half shows only the construction, the left-hand half is with trays;

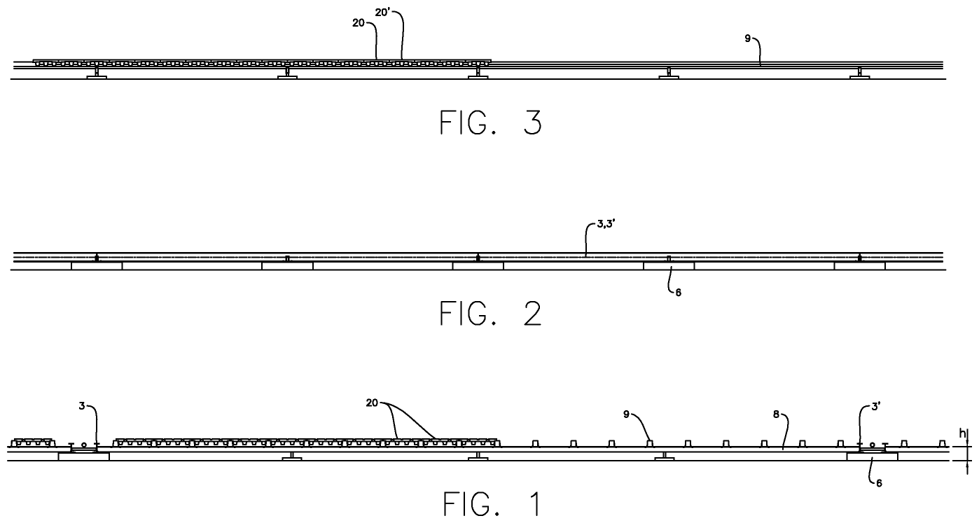

FIG. 2 shows a side view of the rail construction with foundation slabs;

FIG. 3 shows a side view of the rolled profiles on the supporting construction. The right-hand half shows only the construction, the left-hand half is with trays;

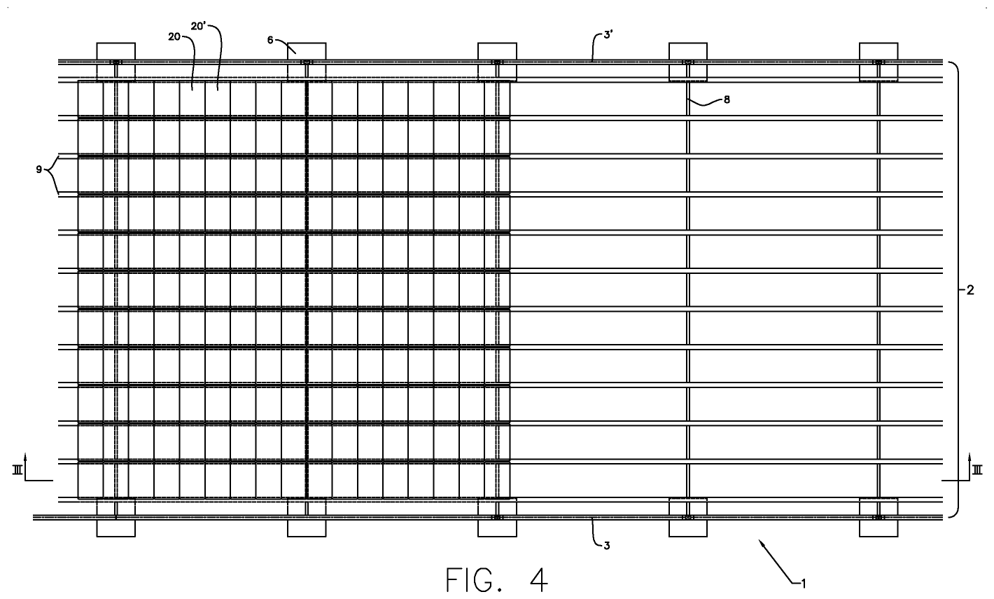

FIG. 4 shows a top view of one track with a longitudinal girder (provided with rails) on either side;

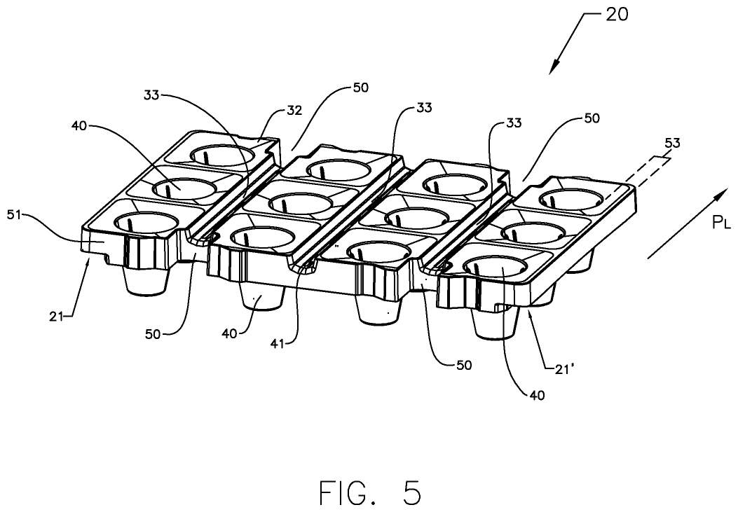

FIG. 5 shows a perspective view of an embodiment of the tray;

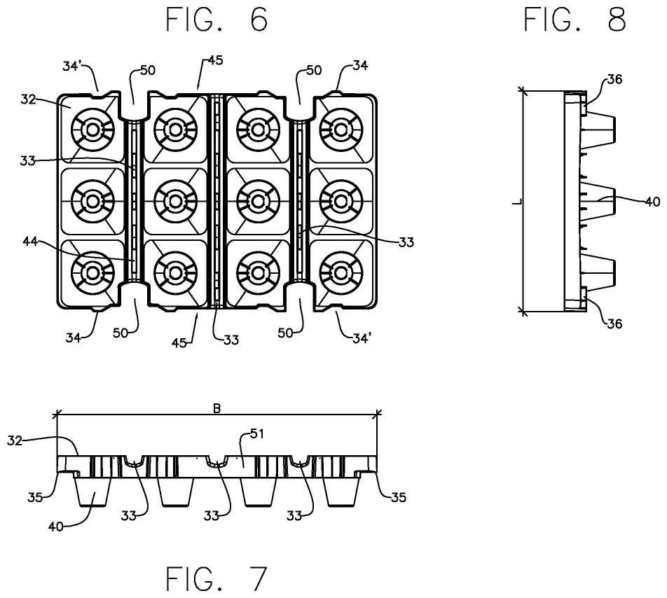

FIG. 6 shows a top view of the tray in the embodiment of FIG. 5;

FIG. 7 shows a front view of the tray in the embodiment of FIGS. 5 and 6;

FIG. 8 shows a side view of the tray in the embodiment of FIGS. 5-7;

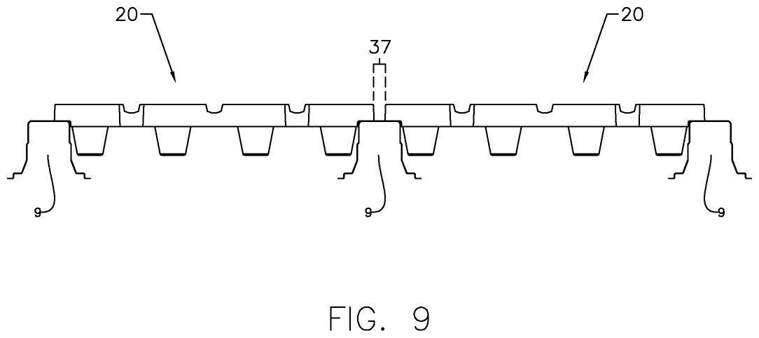

FIG. 9 shows a detail of the girder profiles with trays.

FIGS. 1-4 show an example of a greenhouse system 1 for cultivating a crop or precursor thereof. In the shown example the greenhouse system 1 comprises a minimum of one track 2 of a determined length. The number of tracks can be increased in unlimited manner in the width. The usual width of the tracks can lie between for instance 5 and 20 metres. The length of the tracks can vary, depending on the land available, from for instance 50 to 500 metres. The height (h in FIG. 1) of the system is variable, but a usual height is for instance 0.3 metre. Greenhouse system 1 comprises per track 2 two longitudinal profiles 3, 3′ on both longitudinal sides along the whole length of the track. Longitudinal profiles 3, 3′ are supported by (concrete) foundation slabs 6 for the purpose of distributing the load on the ground surface. The dimensions of the longitudinal girders and slabs depend on the load and load-bearing capacity of the ground in the relevant application. When there are a plurality of tracks alongside each other, the longitudinal girders can be coupled to one slab. There is space for instance for a spray line between the tracks.

Placed transversely between longitudinal girders 3, 3′ are transverse girders 8, again at a determined centre-to-centre distance. Depending on the load and the width of track 2, these transverse girders 8 can be further supported by one or more legs. The legs can be provided with a slab or large base plate for the purpose of distributing the load on the ground.

Girder profiles 9 can be placed over transverse girders 8 and in the lengthwise direction of track 2. These girder profiles serve as support construction for trays 20. Girder profiles 9 have sufficient load-bearing capacity for the span between transverse girders 8.

FIGS. 5-8 show an exemplary embodiment of a tray 20. In the example of the figures the tray 20 has a width (B) of 580 mm and a length (L) of 400 mm, although many variations are of course possible herein. The number of plants in length and width direction can also differ.

FIG. 9 shows that tray 20 supports with its two longitudinal edges 21, 21′ on two girder profiles, wherein each tray 20 lies on a half of a girder profile. Greenhouse system 1 can thus be fully covered with trays 20, wherein a gap 37 remains between adjacent trays in the longitudinal direction, which gap has the same function (automated trimming or cutting) as the groove-like recesses 33.

Each tray 20 comprises an upper wall 32 with a number of holders 42 for holding therein the crop or precursor thereof. Holders 42 are formed by a number of longitudinally extending rows of cup-shaped recesses 40 in upper wall 32. The upper wall 32 also comprises a number of groove-like recesses 33 arranged between adjacent rows of cup-shaped recesses 40 and extending in longitudinal direction (P_{L}). These groove-like recesses 33 enable the automated trimming or cutting of the tendrils of the plants using a suitable crop treatment unit. In the shown embodiment the bottom 41 of groove-like recesses 33 is provided with holes 44 for discharging water and for ventilation. The grooves can have several different shapes and dimensions. The number thereof may also vary. The bottom 41 of groove-like recess 33 moreover takes a rounded form in order to prevent dirt from being able to accumulate therein.

The tray 20 comprises guides 36 formed on the lateral side edges of the tray for the purpose of guiding the tray 20 between the side surfaces of adjacent girder profiles of greenhouse system 1. Tray 20 further comprises a number of sliding surfaces 35 formed on the undersides of the two lateral side edges of the tray for the purpose of supporting the tray for sliding (i.e. displace ably) on top of girder profiles of a greenhouse system 1.

Tray 20 is further provided at the two longitudinal outer ends 45 with one or more aligning elements 34, 34′ for the purpose of mutually aligning the trays. These aligning elements can be formed by respective protrusions 34 and recesses 34′ which can engage in each other in order to prevent relative displacement of the trays in the transverse direction.

In order to be able to remove trays 20 from greenhouse system 1 they are moved (shifted) over the profiles. When the whole greenhouse system 1 is fully covered (over a length of for instance±200 metres), there is no space to engage trays 20. This is because the trays are displaced in the longitudinal direction (P_{L}) over their full track width (typically for instance±12 metres) and by 5-6 metres at a time. Recesses 50 are therefore provided in trays 20 in order to engage and be able to displace the trays 20, for instance with movable pins on the crop carriage. In the shown embodiment the two longitudinal outer ends 45 of tray 20 are more particularly provided with a number of recesses 50 (in the shown example four, although this number may vary) arranged in the upper wall 32. The part of the upper wall 32 (and/or the strengthening walls 51) adjacent to these recesses 50 provide for suitable engaging surfaces with which tray 20 can be engaged and moved. In the shown embodiment these recesses 50 are arranged in the groove-like recess 33 of upper wall 32. Alternatively or additionally, the recesses can also be arranged in the upper, non-recessed flat part of the upper wall 32. Recesses 50 make it possible to engage the tray 20 during the automated moving/displacing of the tray 20 over the underlying girder profiles.

The groove-like recesses 33 make it possible to remove tendrils of (trim) the plants. Owing to these recesses 33, a crop treatment unit, such as a crop trimming unit (not shown), can be applied to be able to trim the (runners) off the plants.

The part (FIG. 5) of the upper wall 32 between a row of cup-shaped recesses 40 and a groove-like recess 33 has a support surface 53 for supporting a crop or precursor thereof arranged in the cup-shaped recesses. This support surface preferably has a width of at least 1 cm, still more preferably at least 2 cm.

The present invention is not limited to the embodiments thereof described here. The rights sought are rather determined by the following claims, within the scope of which many modifications can be envisaged.

1. A tray for cultivating a crop or a precursor thereof, particularly a strawberry plant cultivation tray, wherein the tray comprises an upper wall with a number of holders for holding therein the crop or precursor thereof, wherein the holders are formed by a number of longitudinally extending rows of cup-shaped recesses in the upper wall, and wherein the upper wall also comprises a groove-like recess arranged between adjacent rows of cup-shaped recesses and extending in longitudinal direction.

2. The tray according to claim 1, comprising at least three rows of cup-shaped recesses, wherein at least one groove-like recess is arranged between adjacent rows of cup-shaped recesses.

3. The tray according to claim 1, wherein the tray comprises a number of sliding surfaces formed on undersides of two lateral side edges of the tray fora purpose of supporting the tray for sliding on top of girder profiles of a greenhouse system.

4. The tray according to claim 1, guides formed along the lateral side edges of the tray fora purpose of guiding the tray between the side surfaces of adjacent girder profiles of a greenhouse system.

5. The tray according to claim 1, wherein the tray is provided at two longitudinal outer ends with one or more aligning elements for mutually aligning the tray with another tray,
wherein the aligning elements comprise recesses and corresponding protrusions, and
wherein the recesses and protrusions are provided at corresponding positions so that they can engage in each other during use.

6. (canceled)

7. The tray according to claim 1, wherein the groove-like recess extends over substantially the whole length of the tray.

8. The tray according to claim 1, wherein the groove-like recesses are embodied to form a substantially uninterrupted passage when a number of trays are placed one behind the other.

9. The tray according to claim 1, wherein a width of the groove-like recess is constant over substantially the whole length of the tray.

10. The tray according to claim 1, wherein a cross-section of the groove-like recess is embodied for guiding along a crop treatment unit therein.

11. The tray according to claim 1, comprising a number of depending strengthening walls extending in transverse direction and formed on an underside of the upper wall and on an underside of the groove-like recesses.

12. The tray according to claim 1, wherein a part of the upper wall between a row of cup-shaped recesses and a groove-like recess has a support surface for supporting a crop or precursor thereof arranged in the cup-shaped recesses, wherein the support surface preferably has a width of at least 1 cm, still more preferably at least 2 cm.

13. The tray according to claim 1, wherein the upper wall has a non-recessed part, and the non-recessed part takes a substantially flat form.

14. The tray according to claim 1,
wherein the upper wall comprises a number of recesses which define engaging surfaces whereby the tray can be engaged and moved,
wherein the recesses are optionally arranged in an upper, non-recessed flat part of the upper wall and/or in the groove-like recess, and/or
wherein the recesses are optionally provided at longitudinal outer ends of the groove-like recesses.

15. (canceled)

16. (canceled)

17. The tray according to claim 1, wherein the groove-like recess comprises a bottom and wherein one or more openings are arranged in the bottom.

18. The tray according to claim 17, wherein the bottom of the groove-like recess is rounded and/or chamfered.

19. The tray according to claim 1, wherein the tray is manufactured from plastic and/or wherein the tray comprises four rows of in each case three cup-shaped recesses.

20. A greenhouse system for cultivating a crop or precursor thereof, provided with a number of trays as defined in claim 1, the greenhouse system comprising:
at least two elongate tracks for supporting at least a first and a second row of trays, wherein the tracks comprise at least three parallel girder profiles and a number of support parts for supporting the girder profiles at a substantially constant distance relative to a ground surface, and wherein at least one girder profile is embodied for supporting both the first row of trays and the second row of trays simultaneously.

21. (canceled)

22. The greenhouse system according to claim 20, wherein each girder profile is embodied to support the tray over the whole length thereof and/or wherein the girder profiles are manufactured from rolled profile material, in particular from rolled strip steel and/or wherein the profiles take a smooth form at an upper outer end in order to enable displacement of the tray in longitudinal direction.

23. The greenhouse system according to claim 20, configured to support the trays clear of the ground surface, preferably at a constant height, still more preferably at a constant height in a range of 0.2 to 0.6 m, and/or wherein the support parts are formed by legs provided at a mutual distance from each other.

24. The greenhouse system according to claim 20, wherein two longitudinal edges of the trays support simultaneously on two girder profiles such that a gap remains between adjacent trays.

25. (canceled)
